(19) United States
(12) Patent Application Publication
(10) Pub. No.: US 2026/0350129 A1
(43) Pub. Date: Nov. 5, 2026

(54) STRONG AUTHENTICATION METHOD AND DEVICE

(71) Applicant: WORLDLINE, PUTEAUX (FR)

(72) Inventors: Guillaume LEFEBVRE, MEURCHIN (FR); Wael ELLOUMI,, BLOIS (FR); Cyril CAUCHOIS, WIMEREUX (FR)

(21) Appl. No.: 19/120,355

(22) PCT Filed: Sep. 19, 2023
(86) PCT No.: PCT/FR2023/051428

§ 371 Date: Apr. 11, 2025

(30) Foreign Application Priority Data
Oct. 13, 2022 (FR) FR2210543

(51) Int. Cl. G06F 21/32; G06F 21/64; G06T 19/00; G06V 40/20

(52) U.S. Cl. CPC G06F 21/32; G06F 21/64; G06T 19/006; G06V 40/28

(57) ABSTRACT

The invention relates to a method for authenticating a user wearing a device for immersion in a virtual space, the method comprising: detecting (415) a first hand of the user placed in front of a camera of the immersion device; displaying (420) a representation of the first hand of the user in the virtual space while the first hand is detected; displaying (430) at least one virtual authentication object projected onto the representation of the first hand in the virtual space; detecting (440) interaction movements performed by the user in the virtual space with the at least one virtual authentication object while the at least one virtual authentication object is displayed projected on the representation of the first hand in the virtual space; obtaining (470) an authentication decision based on at least two authentication factors, including a first biometric factor verified from a biometric print acquired by the immersion device for the first hand while the first hand is detected and a second knowledge factor verified by comparing the detected interaction movements with a time series of secret interaction movements known to the user.

### TECHNICAL FIELD

The present description relates to the general field of virtual or augmented reality, and relates more specifically to a method for authenticating a user wearing an device for immersion in a virtual environment, hereinafter referred to as a “virtual reality headset”, “VR headset” (VR, for “Virtual Reality”) or more generically “immersion device”.

It relates more specifically to a strong authentication method and device applicable during the reproduction of audiovisual content in a virtual space by means of such a device.

### TECHNICAL BACKGROUND

In the case of a virtual reality environment, virtual audiovisual content is digitally created and represented in a virtual space, which is generally three-dimensional. In the case of augmented reality, also known as hybrid or mixed reality, virtual content (sounds, images, graphics, GPS positioning information, etc.) is mixed in the virtual space with real content resulting from a capture of the real world, for example by means of a camera. The sensation of immersion in the virtual space is generally enhanced by stereoscopic or three-dimensional reproduction of the video component and by spatialization of the audio component of the audiovisual content.

There is a need for a strong user authentication solution applicable in a virtual environment, allowing a high level of security, a seamless (“frictionless”) immersive experience, and notably one that does not require the user to leave the virtual world, interrupt the reproduction of the audiovisual content by the headset or remove their VR headset.

### SUMMARY

The scope of protection is defined by the claims.

According to a first aspect, the present description relates to a method for authenticating a user wearing a device for immersion in a virtual space. The method comprises
detecting a first hand of the user placed in front of a camera of the immersion device;
displaying a representation of the first hand of the user in the virtual space while the first hand is detected;
displaying at least one virtual authentication object projected onto the representation of the first hand in the virtual space;
detecting interaction movements performed by the user in the virtual space with said at least one virtual authentication object while said at least one virtual authentication object is displayed projected on the representation of the first hand in the virtual space;
obtaining an authentication decision of the user based on at least two authentication factors including a first biometric factor verified from a biometric print acquired by the immersion device for the first hand while the first hand is detected and a second knowledge factor verified by comparing the detected interaction movements with a time series of secret interaction movements known to the user.

According to one or more embodiments, the representation of the first hand is a representation of the palm of the first hand.

According to one or more embodiments, the representation of the first hand is displayed at a position in the virtual space corresponding to the position of the first hand in the real space where the user is located while the interaction movements are performed; the representation of the first hand in the virtual space as well as said at least one virtual authentication object projected onto the representation of the first hand follow any movement of the first hand in the real space.

According to one or more embodiments, the representation of the first hand of the user in the virtual space is obtained from at least one image of the first hand of the user acquired by a camera of the immersion device.

According to one or more embodiments, the display of said at least one virtual authentication object projected onto the representation of the first hand is performed so that, when the user performs the interaction movements with said at least one virtual authentication object, physical contact with the first hand occurs. According to one or more embodiments, the detection of interaction movements comprises the detection of movements performed with the second hand of the user, detected by the immersion device and represented in the virtual space at the same time as the first hand. Physical contact can occur between the first hand and the second hand when the user performs the interaction movements.

According to one or more embodiments, the detection of interaction movements comprises the detection of movements performed by a virtual interaction object represented in the virtual space. The virtual interaction object can be for example a virtual object present in the audiovisual content reproduced by the immersion device or a virtual object representing a real object manipulated by the user. In the case of a real object manipulated by the user, physical contact can occur between the first hand and the real object when the user performs the interaction movements.

According to one or more embodiments, the detection of interaction movements comprises the detection of movements performed in the real world with the first hand of the user so that the representation of the first hand in the virtual space moves with respect to a fixed virtual interaction object present in the virtual space, the representation of the first hand being displayed at a position in the virtual space corresponding to the position of the first hand in the real space where the user is located while the interaction movements are performed. The virtual interaction object can be for example a fixed virtual object in an audiovisual content reproduced by the immersion device or a virtual object representing a fixed real object. In the case of a fixed real object, physical contact can occur between the first hand and the fixed real object when the user performs the interaction movements.

According to one or more embodiments, said at least one virtual authentication object comprises a device for entering a secret code corresponding to a time series of input actions forming the time series of secret interaction movements known to the user; the detection of interaction movements comprising the detection of input actions performed by the user by interaction with the input device.

According to one or more embodiments, said at least one virtual authentication object comprises several virtual authentication objects each associated with at least one respective interaction movement, the time series of interaction movements known to the user being a time series of interaction movements, each of which is an interaction movement associated with one of the virtual authentication objects. An interaction movement with a virtual authentication object may comprise, for example, at least one movement among a movement for moving the virtual object, a movement for rotating the virtual object, a movement for selecting the virtual object and a movement for modifying the appearance of the virtual object.

According to a second aspect, the present description relates to a device comprising means for implementing a method according to the first aspect.

The means may be software and/or hardware means. These means may comprise, for example, one or more circuits configured to execute one or more or all of the steps of one of the method according to the first aspect. The means may comprise, for example, at least one processor and at least one memory comprising program instructions configured to cause, when executed by the processor, the device to execute one or more or all of the steps of one of the method according to the first aspect.

According to another aspect, the present description relates to a storage medium that is readable by a data processor on which is stored a program comprising program instructions configured to cause the data processor to execute one or more or all of the steps of the method according to the first aspect.

According to another aspect, the present description relates to a computer program comprising program instructions configured to cause a data processor to execute one or more or all of the steps of the method according to the first aspect.

### BRIEF DESCRIPTION OF THE FIGURES

Further features and advantages will become apparent from the following detailed description, based on illustrative and non-limiting embodiments and examples, with reference to the accompanying figures.

FIG. 1 schematically shows a virtual reality system according to an example embodiment.

FIG. 2 is a block diagram of an immersion device according to an example embodiment.

FIG. 3 is a flowchart illustrating a method for enrolling a user according to an example embodiment.

FIG. 4 is a flowchart illustrating a method for authenticating a user according to an example embodiment.

FIG. 5 illustrates aspects of an authentication method according to an example embodiment.

FIG. 6 illustrates aspects of an authentication method according to an example embodiment.

### DETAILED DESCRIPTION

Various embodiments will now be described in more detail with reference to the drawings. The specific structural and/or functional details disclosed here are used to provide an understanding of the various possible embodiments. However, a person skilled in the art will understand that the exemplary embodiments may be subject to various modifications and may be implemented without all of these details.

The present description relates to a strong authentication method and device applicable during the reproduction of audiovisual content in a virtual space by means of an immersion device in a virtual space such as a virtual reality headset.

This strong authentication solution is applicable to any type of virtual reality (VR) systems, including augmented reality (AR), mixed reality (MR) or extended reality (XR) systems. In the context of this document, the term “virtual reality” covers all virtual reality technologies in the broadest sense, including augmented reality, mixed reality or extended reality as well as variants or technologies derived from these technologies.

The strong authentication solution described herein can be used for various applications and/or transactions requiring authentication (e-commerce, video games, payment, banking, etc.).

Strong authentication means authentication based on the verification of at least two different types of authentication factors. There are three types of authentication factors:
biometric factors (based on biometric data);
knowledge factors (based on secret information known only to the user);
ownership factors (based on the use of a user's own hardware device).

The strong authentication method described herein combines at least two authentication factors of different types including a biometric factor (for example, the print of the palm of the hand) and a knowledge factor based on a secret sequence known to the user (which may be a PIN code, a secret code or a secret sequence of at least one action performed on at least one authentication object represented in the virtual world). The secret sequence is entered by the user by interacting with at least one virtual authentication object represented in the virtual world.

The authentication method comprises displaying a representation of a first hand of the user in the virtual space, displaying one or more virtual authentication objects projected onto the representation of the first hand and detecting interaction movements performed by the user in the virtual space with the virtual authentication object(s) while the virtual authentication object(s) are displayed projected on the representation of the first hand in the virtual space.

The authentication decision of the user is made on the basis of at least two authentication factors: a first biometric factor verified from a biometric print acquired by the immersion device for the first hand and a second knowledge factor verified by comparing the detected interaction movements with a time series of secret interaction movements known to the user.

The authentication method simplifies the user experience and makes validation of the transaction requiring authentication more fluid while guaranteeing the security of this validation. The authentication method enables two authentication factors to be captured at the same time, with a single user action.

The authentication method allows strong authentication of an individual in the virtual world with a high level of security, an immersive, seamless and privacy-compliant user experience. The authentication method allows two authentication factors to be captured with a single interaction request for a single user action.

The authentication method allows strong authentication for transaction/payment validation for various immersive applications based on the virtual reality.

This strong authentication solution is inexpensive as it is based solely on the equipment and sensors already available in the user equipment for reproducing virtual reality environments.

Sensors (cameras, gyroscopes, accelerometers, etc.) can thus be used to capture gestures performed by the user. Gesture analysis means (software and/or hardware) can be used to analyze, categorize and/or break down captured gestures. These gesture analysis means can be used to analyze and characterize the behavior of the user in order to perform behavioral biometric authentication: this enables a second biometric factor to be taken into account (in addition to the biometric print acquired for the hand) and enhances the authentication security level.

Gestures performed by the user can be represented in the virtual space, for example by displaying a representation of the hand or hands performing these gestures or by displaying information representative of the gestures detected.

The user can thus move around in the three-dimensional virtual world and interact with virtual objects represented in the audiovisual content using simple gestures, with or without the use of real-world interaction objects, with or without the use of virtual-world interaction objects.

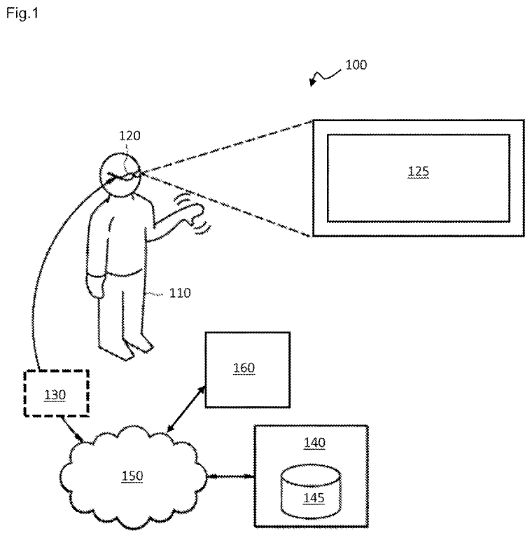

FIG. 1 schematically shows a virtual reality system according to an example embodiment.

The system comprises an immersion device 120 (for example VR headset) worn by a user 110. The immersion device 120 comprises a display screen 125 (typically on an inner face of the headset which is positioned in front of the user's eyes) allowing the user to view the virtual environment in three dimensions (3D).

The immersion device 120 is in operational communication with a remote authentication server 140 associated with an authentication database 145. The immersion device 120 can be in communication with a remote content server 160 providing audiovisual content to be reproduced by the immersion device 120.

In one embodiment, communication with a remote server 140 and/or with the remote content server 160 is established via a telecommunications network 150, either directly or through a local device 130, such as a personal computer.

In one embodiment, the immersion device 120 executes an interaction program implementing an authentication method.

In one embodiment, the interaction program is downloaded to the immersion device 120 from the remote server 140, then executed locally by the immersion device 120 in order to interact with the user and to capture the behavioral, biometric and other interaction data required for authentication.

The captured data can also be analyzed locally. For example, the immersion device can locally perform biometric factor analysis by comparing the acquired biometric print with a reference print (a reference biometric template). For example, the immersion device can locally compare the time sequence of interaction movements with a reference sequence. For security reasons, the reference sequence is not stored in clear text but in encrypted form, for example as a digital hash.

In one or more embodiments, verification of the two authentication factors of the user (biometric+secret sequence) is carried out by the authentication server which transmits the authentication decision to the immersion device.

In one or more embodiments, two-factor verification (biometric+secret sequence) is performed locally by the immersion device. If this immersion device is not recognized as a trusted terminal, the level of risk is higher than in the case of verification on the authentication server side. To reduce this risk, the authentication server can identify the immersion device of the user (based on an ownership factor, in addition to the other two authentication factors of the user) and verify its authenticity. Various authentication procedures are available for the immersion device. For example, the authentication server sends the immersion device a random challenge to be signed for each user authentication request. The immersion device signs the challenge and then transmits the signature with the result of the user's authentication based on the two authentication factors (biometric+secret sequence) to the authentication server. The authentication server verifies the authenticity of the immersion device on the basis of the data received and decides whether or not to validate the authentication result for the user. In this fashion, the final decision always rests with the server.

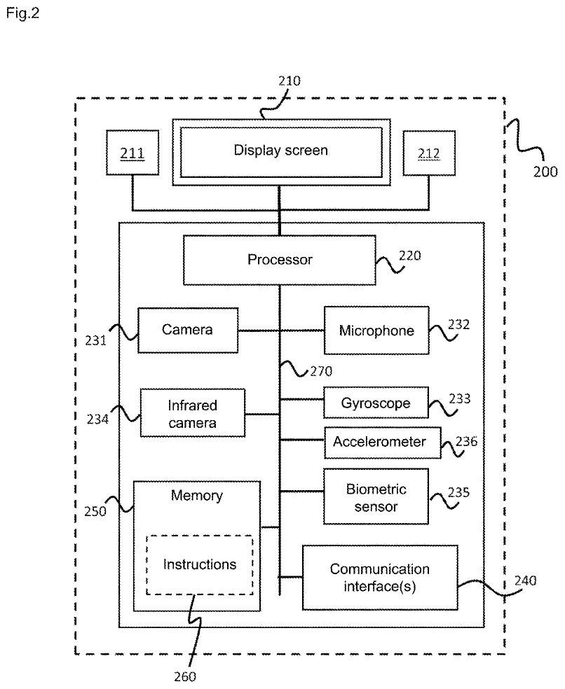

FIG. 2 is a block diagram of an immersion device 200 according to an example embodiment. The immersion device 200 may have the overall architecture of a computer, including the components of such an architecture: data memory(ies) 250, processor(s) 220, communication bus 270, communication interface(s) 240 for connecting this immersion device 200 to a telecommunications network or other local or remote equipment.

The immersion device 200 comprises a display screen 210 for reproducing images of audiovisual content and loudspeakers 211, 212 for reproducing the sound of the audiovisual content.

The immersion device 200 may comprise various acquisition devices: camera 231, infrared camera 234, depth camera, microphone 232, biometric sensor 235, gyroscope 233, accelerometer 236, etc.

The camera and/or the infrared camera and/or the gyroscope can for example be used to capture gestures performed by the user. Gesture analysis means (software and/or hardware) can be used to analyze, categorize and/or break down captured gestures. For example, the memory 250 can comprise program instructions 260 configured to be executed by the processor and implement gesture analysis functions. These gesture analysis functions can be provided in the form of libraries adapted to the immersion device 200.

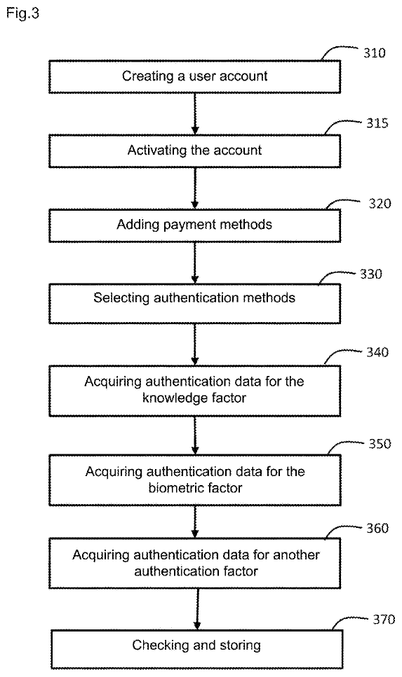

FIG. 3 is a flowchart illustrating a method for enrolling a user according to an example embodiment. This method corresponds to an enrollment phase.

The enrollment method can be executed by means of an enrollment program executed by an immersion device 120, 200 described with reference to FIG. 1 or 2, this immersion device being in operational communication with an authentication server 140 as described for example with reference to FIG. 1.

In some embodiments, the execution of certain functions (notably calculation or data storage functions) can be deported to a local device 130 (such as a personal computer) connected via a local link to the immersion device 120, 200. In this case, the immersion device and the local device 130 cooperate to implement the enrollment method.

In step 310, the user is asked to create a user account for a given application (video game, e-commerce, payment, etc.). The user account can be created in a variety of ways and typically comprises entering a user name and password. For example, the user enters an e-mail address as an identifier and a password consisting of a numeric or alphanumeric sequence of their choice.

In step 315, the data entered by the user in step 310 is received by the authentication server and verified. If they comply with security rules, the user's account is successfully created and activated, and the user is informed thereof. The identifier and the password provided in step 310 are stored in association with an identifier for the user account. The identifier and the password can be stored in the authentication database 145. The password can also be stored locally, for example in the immersion device, in encrypted form, usually by means of a digital hash which can be compared with a digital hash of a password subsequently entered by the user.

In step 320, the user may be asked to specify one or more payment methods. For example, the user can enter banking data, for example identification data for a payment card. In this case, the data relating to the payment methods provided is stored in association with the user account data, for example in the authentication database 145. When a payment card has been identified, a payment token (for example, EMV token) can be stored to avoid storing the identification data of a payment card.

In step 330, the user may be asked to select an authentication method. Each authentication method corresponds to a type of secret sequence which can be used as a knowledge factor. For example a list of secret sequence types is proposed and the user can select one or more thereof depending on the degree of security required.

The list of secret sequence types can comprise:
a PIN code or numeric sequence;
an alphanumeric sequence;
a sequence of symbols or drawings or figures;
a time sequence of interactions with one or more virtual objects;
any other secret sequence that can be stored and reproduced by the user in a virtual space.

Alternatively, instead of asking the user to select a secret sequence type, a secret sequence type (or an authentication method) is selected by the authentication server or an administrator user from the possible types.

In step 340, the user authentication data corresponding to one or more knowledge factors is acquired and stored for the authentication method(s) (or secret sequence types) selected in step 330.

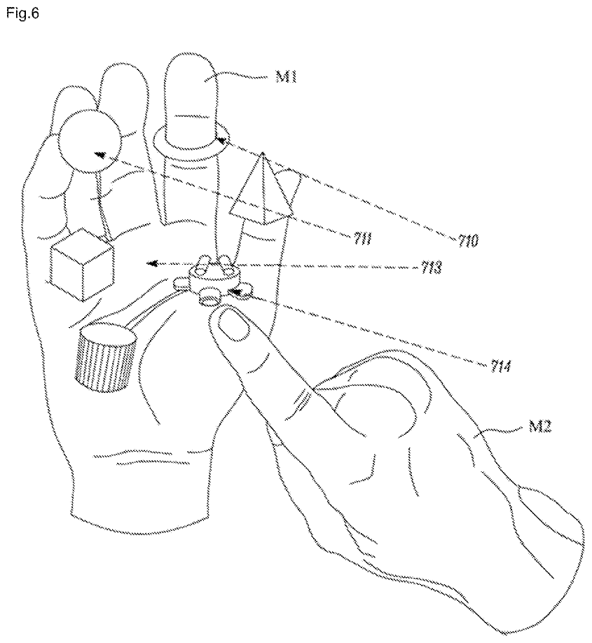

The acquisition and storing of the authentication data can be performed via the virtual environment, using a representation of a first hand of the user in the virtual space, by displaying one or more virtual authentication objects projected onto the representation of the first hand and by detecting interaction movements performed by the user in the virtual space with the virtual authentication object(s) while the virtual authentication object(s) are displayed projected on the representation of the first hand in the virtual space as shown in FIGS. 6 and 7.

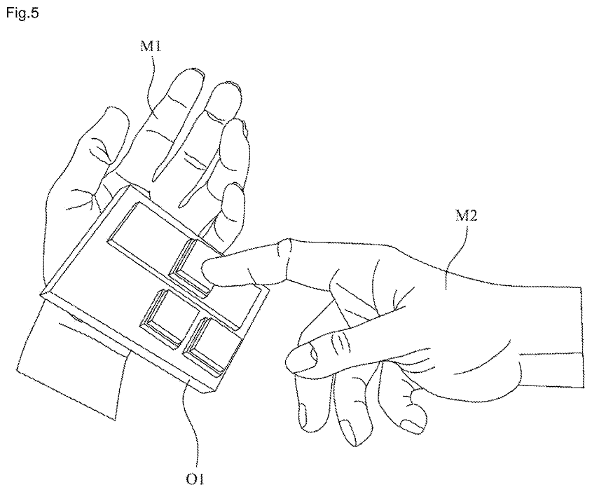

For example, if the authentication method selected is based on a secret code (PIN code or alphanumeric sequence), the user is asked to enter this secret code by means of a virtual authentication object corresponding to a code entry device, for example a numeric virtual keyboard O1 or an alphanumeric virtual keyboard O1 represented in the virtual space as shown in FIG. 5.

For example, if the authentication method selected is based on a secret sequence of symbols, the user is asked to enter the secret sequence by means of a virtual authentication object corresponding to a virtual keyboard featuring keys with one symbol per key. The user can select which symbols are displayed on the keys and/or the number of symbols on the keyboard. Symbols can be selected by selecting symbols from a predefined set of symbols which is presented to the user or by selecting (for example from virtual or non-virtual video content and/or images) images or image blocks as symbols.

For example, if the authentication method selected is based on reproducing a time sequence of interactions with predefined virtual objects, the user can select virtual objects present in a virtual content and perform the time sequence of interactions with the virtual objects selected.

An interaction with a virtual object can be for example: an action of moving the virtual object, an action of rotating or pivoting the virtual object, an action of selecting the virtual object, an action of modifying the appearance of the virtual object, etc. Each interaction corresponds to an interaction movement which can be detected by analyzing images acquired by a camera of the immersion device.

To store the secret reference sequence during enrollment, the user must select one or more secret virtual objects from their virtual environment and define a certain number of actions or combinations of actions on the secret virtual objects 710, 711, 713, 714, for example: rotate object 710, change the color of object 711, modify the size of object 713, move object 714 to the right, etc., as shown in FIG. 6. This sequence of actions constitutes its secret reference sequence to be replayed during the authentication phase. In particular, during the authentication phase, the user must select the secret virtual objects selected during enrollment and interact with these objects in order to replay the sequence of actions defined during the enrollment phase for the knowledge factor (see step 440 in particular).

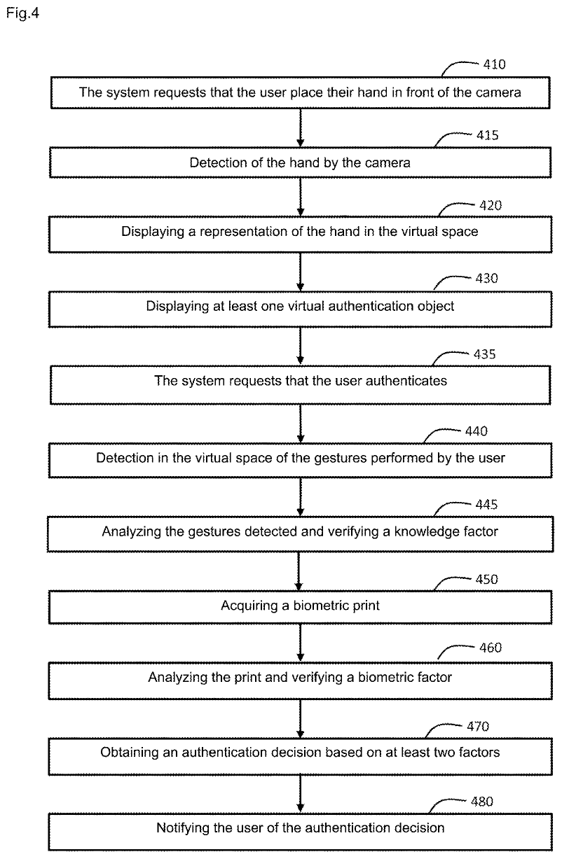

Other example embodiments are described with reference to FIGS. 4 to 6.

Whichever authentication method is selected, reference authentication data corresponding to a knowledge factor is stored at the end of step 340. This authentication data comprises a description of a secret sequence (secret code or other), used as a reference.

This reference authentication data is preferably stored in encrypted form or else stored as a digital hash. For example, the reference authentication data comprises:
a hash of the Pin code entered,
a hash of the positions of virtual authentication objects on the hand;
a hash of the reference secret sequence.

Each of the interaction movements in the reference sequence can be associated with keywords identifying the type of interaction movement from the types of interaction movement (selection of the virtual authentication object, translation of the virtual authentication object, rotation of the virtual authentication object, modification of the appearance of the virtual authentication object, etc.), together with any parameters specific to this type of interaction movement. The secret sequence is coded in the form of a list, which may or may not be ordered, of keywords identifying the type of interaction movement.

Whichever authentication method is selected, the secret sequence is defined by a time series of interaction movements with the virtual authentication object(s), this time series of interaction movements having to be reproduced by the user in the virtual space in order to be authenticated.

In some embodiments, several secret reference sequences are stored and all are required for user authentication.

In some embodiments, several secret reference sequences are stored, but only one is randomly selected for user authentication.

In step 350, user biometric authentication data corresponding to one or more biometric factors is acquired and stored. A biometric factor can relate for example to the user's eye, voice, face or hand. The focus herein is more particularly on the biometric factors associated with the user's hand.

In this case, the biometric authentication data acquired for a hand may comprise one or more biometric prints among:
a biometric print of the palm of the hand (palm print);
a print of the venous network of the palm of the hand;
fingerprints of fingers of the hand;
a biometric print of the hand: overall shape of the hand and fingers in two or three dimensions, with or without palm image, with or without fingertip image, etc.;
a combination of these prints.

In a known way, each biometric print can be acquired by means of a suitable biometric sensor. According to one example, a palm print of the hand can be acquired from an image of the hand acquired by the camera. According to another example, a print of the venous network of the palm of the hand can be acquired from an infrared image by an infrared camera.

If the immersion device has both a camera and an infrared camera, it is possible for example to store not only the palm print acquired from an image of the palm of the hand, but also a print of the venous network of the hand acquired by means of the infrared camera as well as the 3D shape of the hand. This not only improves recognition performance but above all makes it possible to counter spoofing attacks, which consist in presenting a false biometric sample to the biometric sensor (digital image, printed photo of the hand, etc.)

In step 360, user authentication data corresponding to one or more additional factors with respect to those in steps 340 and 350 (for example, ownership factor) can be stored.

For example, an ownership factor based on the exchange of cryptographic keys between the immersion device 120 and the authentication server 140 can be implemented so as to enable authentication of the immersion device 120 by the authentication server 140 based on cryptographic keys. In this case, the stored authentication data comprises one or more cryptographic keys.

In step 370, the authentication data obtained in steps 340, 350 and 360 is verified and then stored (for example in an authentication database 145) in association with the data of the user account created in step 315. This data serves as reference authentication data. It is stored in encrypted form or else stored as a digital hash. For example, the authentication data comprises:
a Hash of the Pin Code Entered;
a hash of the positions of virtual authentication objects on the hand;
a hash of the reference secret sequence.

The verification carried out at this stage relates to, for example, the biometric data and more specifically the quality of the biometric sample captures (image of the palm of the hand) which may, for example, be blurred or insufficiently illuminated, so as to enable extraction for the reference biometric template used for authentication. Indeed, if the extraction of characteristics and the calculation of the reference biometric template are successful then the acquired authentication data is validated and the biometric template will be stored. If this is not possible, the step of acquiring biometric authentication is repeated along with the step 370 of verifying and storing.

FIG. 4 is a flowchart illustrating a method for authenticating a user according to an example embodiment. This method corresponds to an authentication phase carried out after the enrollment phase.

The authentication method can be carried out for example by means of an immersion device 120, 200 described with reference to FIG. 1 or 2, this immersion device being in operational communication with an authentication server 140 as described for example with reference to FIG. 1.

In step 410, the authentication method is started and the user is asked to place a hand in front of a camera of the immersion device.

In step 415, the hand is detected by the immersion device, by means of the camera for example. At least one image of the hand can be acquired while the hand is being detected by the immersion device.

In step 420, a representation of the first hand of the user is displayed in the virtual space while the first hand is detected.

The representation of the first hand can be a representation of the palm of the first hand. The representation of the first hand of the user in the virtual space can be obtained from at least one image of the first hand of the user acquired by the immersion device (by a camera of the immersion device).

The representation of the first hand of the user can be a stylized or simplified representation, showing for example only the contours of the hand (contours of the fingers and palm) and main reliefs or correspond to a more detailed image of the hand.

In step 430, one or more virtual authentication objects are displayed projected onto the representation of the first hand in the virtual space.

In step 435, the user is asked to authenticate themself by reproducing a secret reference sequence stored during the enrollment phase. This secret sequence is reproduced by interacting with the virtual authentication object(s) displayed projected onto the representation of the first hand in the virtual space.

In step 440, gestures corresponding to interaction movements performed by the user in the virtual space with the authentication virtual object(s) are detected while the virtual authentication object(s) is displayed projected on the representation of the first hand in the virtual space.

Behavioral biometric data representative of the interaction movements of the user are captured using sensors present (accelerometer, gyroscope, camera, etc.) in the immersion device or its peripherals. This data represents the movements of their hands and/or the way in which the user holds and manipulates the objects in their hand, and/or the behavior of the user. This data acquired by these sensors can be analyzed to extract a certain number of parameters characteristic of the behavior of the user such as for example: the speed of movements, the amplitude of movements, the duration of movements, the latency time between two movements, the coordination between the movements of the head and hands, statistical parameters, etc. This behavioral biometric data can optionally be used for behavioral biometric authentication, in addition to the two authentication factors used in step 470.

During this interaction step 440, the representation of the first hand is displayed at a position in the virtual space corresponding to the position of the first hand in the real space where the user is located while the interaction movements are performed. In this way, the first hand serves as a spatial cue for the user in both the real space and the virtual space. In particular, it is easier to interact with a virtual authentication object because of this correspondence between what is visualized in the virtual space and the movements that the user performs in the real space to control these interaction movements with the virtual objects present only in the virtual space.

Additionally, when the user performs the interaction movements with their second hand relative to the first hand in the real space while having a visual representation of the progress of the interaction movements in the virtual space, haptic feedback is provided to the user during interaction with the virtual authentication objects when the user comes to touch the first hand with their second hand during this interaction.

The position of the virtual authentication objects with respect to the first hand in the virtual space can be predefined and depend on the secret sequence to be entered.

Alternatively, the positions of the virtual authentication objects change randomly at each authentication phase.

The virtual authentication objects can be positioned on the hand, in front of the hand or in the vicinity of the hand, notably at a defined distance. FIG. 6 shows examples of positioning of objects on phalanges of a finger, at the base of a finger, around a finger (when the object is a ring) or other positions. In the case of a keyboard, as shown in FIG. 5, the keyboard can be represented as a single object O1 positioned in the palm of the first hand M1 or as several objects corresponding to the keys of the keyboard and distributed spatially. Whether it is a keyboard or objects to be manipulated, the virtual authentication objects can be distributed to randomly selected positions on the representation of the first hand M1 for each new authentication in order to enhance security.

The representation of the first hand in the virtual space and the virtual authentication object(s) projected onto the representation of the first hand follow any movement of the first hand in the real space so that for example the relative position of each of the virtual objects with respect to the first hand in the virtual space does not change, unless the user acts to move one of these virtual authentication objects with respect to the first hand.

According to embodiments, the interaction movements are performed with the second hand (notably the fingers) of the user, the second hand being represented in the virtual space at a position corresponding to that of the second hand in the real space. The representation of the second hand thus serves as a pointer in the virtual space. In this case, the detection of interaction movements comprises the detection of movements performed with the second hand of the user detected by the immersion device and represented in the virtual space at the same time as the first hand.

According to embodiments, the interaction movements can be performed by means of a virtual interaction object (or virtual pointing object) which is represented in the virtual space and serves as a pointer for acting on a virtual authentication object.

This virtual interaction object or pointer can be a virtual interactive object which is present in an audiovisual content being reproduced and which the user can manipulate to use it as a pointer in the virtual world. The movement of the virtual interaction object can be controlled in various ways by the user, for example by means of a peripheral device such as a keyboard, thumbwheel, joystick, mouse, etc.

This virtual interaction object can also be a virtual object representing a real object manipulated by the user in the real world. In this case, a camera is used to detect the movements of the real object manipulated by the user in the real world

According to embodiments, the interaction movements can be performed with the first hand of the user so that the representation of the first hand in the virtual space moves with respect to a fixed virtual interaction object present in the virtual space: in this case too, the representation of the first hand is displayed at a position in the virtual space corresponding to the position of the first hand in the real space where the user is located while the interaction movements are being performed. In this operating mode, the user needs only one hand. This virtual interaction object can be a virtual object which is present and fixed in the audiovisual content. This virtual interaction object can also be a virtual object representing a fixed real object.

Whatever the pointer or the way in which interaction movements are performed, the secret sequence to be reproduced corresponds to an authentication method selected during the enrollment phase (see step 330) and the virtual authentication objects corresponding to the selected method are displayed projected onto the first hand.

According to an example shown in FIG. 5, a virtual authentication object O1 can consist of a virtual keyboard with keys for entering a numeric sequence, an alphanumeric sequence or a sequence of symbols. The virtual keypad is displayed in the palm of a first hand M1. In this case, the user can perform interaction movements to press keys on this virtual keyboard by means of their second hand M2 (for example using the index finger of their second hand) and thus enter a secret sequence.

During this interaction, the index finger of the second hand can come into contact with the palm of the first hand so that haptic feedback is provided to the user, allowing the user to better control their gesture and to do so more precisely and more naturally (because the user knows when they are in contact with the key), notably with less risk of errors.

Instead of using a virtual keyboard to enter a secret code, another type of device for entering a secret code can be used with interaction movements other than keystrokes: for example, code entry wheels for unlocking a safe. In this case, the secret sequence corresponds to a time sequence of wheel rotation actions.

According to another example shown in FIG. 6, one or more virtual authentication objects 710, 711, 713, 714 are used. Each of these virtual objects is associated with one or more respective interaction movements. In this case, the secret sequence can consist of a time series of interaction movements, each of which is an interaction movement associated with one of the virtual authentication objects. An interaction movement with a virtual authentication object can be: a movement from a movement for moving the virtual object, a movement for rotating the virtual object, a movement for selecting the virtual object, a movement for modifying the appearance of the virtual object, etc.

The embodiments, examples and details that have been described for the interaction step 440 relating to the reproduction of the secret sequence are also applicable to step 340 carried out during the enrollment phase for the acquisition of this secret sequence.

In step 445, the interaction movements performed by the user in step 440 are analyzed and compared with a secret reference sequence stored during the enrollment phase (see step 340). This secret sequence consists of a time series of secret interaction movements known to the user. The comparison can be made on the basis of the respective digital hashes of the reference secret sequence and the user's newly performed sequence of interaction movements. This comparison determines whether or not a knowledge factor is verified, depending on whether or not the secret sequence stored during the enrollment phase is correctly reproduced during step 430.

In step 450, one or more biometric prints are acquired from a suitable sensor. According to one example, a palm print of the hand is acquired from an image of the hand acquired by the camera. According to another example, a print of the venous network of the palm of the hand is acquired from an image acquired by an infrared camera.

In step 460, the biometric print(s) acquired in step 450 are compared with reference biometric prints stored during the enrollment phase (see step 350). This comparison determines whether or not a biometric factor has been verified, depending on whether or not the acquired prints match the reference prints stored during the enrollment phase.

In step 470, a user authentication decision based on at least two authentication factors is obtained. The two authentication factors comprise at least:
a first biometric factor verified from a biometric print extracted from said at least one image; and
a second knowledge factor verified by comparing the detected interaction movements with a time series of secret interaction movements known to the user.

Other factors can be used to enhance the level of security, such as for example an ownership factor. For example, an ownership factor can be verified by authentication of the immersion device 120 by the authentication server 140 based on at least one cryptographic key received during the enrollment phase.

In step 480, the user is notified of the authentication decision: positive or negative, depending on whether the user is authenticated or not.

The authentication method enables several authentication factors to be combined for strong authentication.

For example, strong authentication combining two factors, including one based on a palm print and the other on entering a PIN code. Additionally, a third factor can be used: an ownership factor based on the exchange of cryptographic keys between the VR headset and the authentication server. The final authentication decision (rejection or acceptance) is based on the three-factor verification.

For example, strong authentication combining two factors, including one based on a palm print and the other on a secret sequence of interactions with virtual objects.

The authentication solution allows authentication that is strong, transparent, multi-modal, modular, customizable and adaptable to different sensors (it is compatible with several types of sensor).

The authentication solution is inexpensive since it is based solely on the equipment and sensors available in VR headsets.

The authentication solution offers a good compromise between security and user experience.

In some embodiments, because physical contact is made with the first hand used to project the authentication objects during the interaction movements performed by the user, haptic feedback is generated. This considerably enhances the user experience which provides an immersive, ultra-realistic sensory experience, as well as helping to guide/manipulate objects precisely. The physical contact with the first hand can be made either with the second hand, or with another real object, manipulated by the user and represented in the virtual environment at the same time as the first hand.

In the description of the various phases and methods, although the steps are described sequentially, the person skilled in the art will understand that some steps may be omitted, combined, performed in a different order and/or in parallel.

One or more or all of the steps in one or more of the methods described in this document can be implemented by software or a computer program and/or by hardware, e.g. by circuitry, whether programmable or not, specific or not.

The functions, steps and methods described herein can be implemented by software (for example, via software on one or more processors, for execution on a general-purpose or special-purpose computer) and/or implemented by hardware (for example, one or more electronic circuits, and/or any other hardware component).

The present description thus relates to a computer program or software, capable of being executed by a host device (for example, an immersion device) acting as an authentication device, by means of one or more data processors, this program/software comprising instructions for causing said host device to execute all or some of the steps of one or more of the methods described in this document. These instructions are intended to be stored in a memory of the host apparatus, loaded and then executed by one or more processors of this host apparatus so as to cause this host apparatus to execute the method in question.

This software/program may be coded using any programming language, and may be in the form of source code, object code, or intermediate code between source code and object code, such as in a partially compiled form, or in any other desirable form.

The host apparatus can be implemented by one or more physically separate machines. The host apparatus may have the overall architecture of a computer, including the components of such an architecture: data memory(ies), processor(s), communication bus(es), hardware interface(s) for connecting this host apparatus to a network or other device, user interface(s), etc.

In one embodiment, some or all of the steps of the authentication method or other method described in this document are implemented by an authentication device equipped with means for implementing those steps of this method.

These means may comprise software means (for example instructions of one or more program components) and/or hardware means (for example data memory(ies), processor(s), communication bus, hardware interface(s), etc.).

These means may comprise for example one or more processing circuitry configured to execute one or more or all of the steps of one of the methods described herein. These means may comprise, for example, at least one processor and at least one memory comprising program instructions configured to, when executed by the processor, cause the apparatus to perform one, more or all of the steps of one of the processes described herein.

Means implementing a function or a set of functions may also refer in this document to a software component, a hardware component or a set of hardware and/or software components, able to implement the function or the set of functions, as described below for the means concerned.

The present description also relates to an information medium readable by a data processor, and having instructions of a program as mentioned above.

The information medium may be any hardware means, entity or device, capable of storing the instructions of a program as mentioned above. Usable program storage media include ROM or RAM memories, magnetic storage media such as magnetic disks and tapes, hard drives or optically readable digital data storage media, etc., or any combination thereof.

In some cases, the computer-readable storage medium is not transitory. In other cases, the information medium may be a transient medium (for example, a carrier wave) for the transmission of a signal (electromagnetic, electrical, radio or optical signal) carrying program instructions. This signal can be conveyed via an appropriate transmission medium, wired or wireless: electrical or optical cable, radio or infrared link, or by other means.

One embodiment also relates to a computer program product comprising a computer-readable storage medium having program instructions stored thereon, the program instructions being configured to cause the host apparatus (for example a computer) to implement some or all of the steps of one or more of the methods described herein when the program instructions are executed by one or more processors and/or one or more programmable hardware components of the host apparatus.

1. A method for authenticating a user wearing a device for immersion in a virtual space, the method comprising detecting a first hand of the user placed in front of a camera of the immersion device;
displaying a representation of the first hand of the user in the virtual space while the first hand is detected;
displaying at least one virtual authentication object projected onto the representation of the first hand in the virtual space;
detecting interaction movements performed by the user in the virtual space with said at least one virtual authentication object while said at least one virtual authentication object is displayed projected on the representation of the first hand in the virtual space;
obtaining a user authentication decision based on at least two authentication factors including a first biometric factor verified from a biometric print acquired by the immersion device for the first hand while the first hand is detected and a second knowledge factor verified by comparing the detected interaction movements with a time series of secret interaction movements known to the user.

2. The method according to claim 1, wherein the representation of the first hand is a representation of the palm of the first hand.

3. The method according to claim 1,
wherein the representation of the first hand is displayed at a position in the virtual space corresponding to the position of the first hand in the real space where the user is located while the interaction movements are performed;
wherein the representation of the first hand in the virtual space and said at least one virtual authentication object projected onto the representation of the first hand follow any movement of the first hand in the real space.

4. The method according to claim 1, wherein the display (430) of said at least one virtual authentication object projected onto the representation of the first hand is performed so that, when the user performs the interaction movements with said at least one virtual authentication object, physical contact with the first hand occurs.

5. The method according to claim 1, wherein the detection of interaction movements comprises the detection of movements performed with the second hand of the user detected by the immersion device and represented in the virtual space at the same time as the first hand.

6. The method according to claim 4, wherein the physical contact occurs between the first hand and the second hand.

7. The method according to claim 1, wherein detecting interaction movements comprises detecting movements performed by a virtual interaction object represented in the virtual space, wherein the virtual interaction object is a virtual object present in audiovisual content reproduced by the immersion device.

8. The method according to claim 1, wherein detecting interaction movements comprises detecting movements performed by a virtual interaction object represented in the virtual space, wherein the virtual interaction object is a virtual object representing a real object manipulated by the user.

9. The method according to claim 4, wherein the physical contact occurs between the first hand and the real object manipulated by the user.

10. The method according to claim 1, wherein the detecting interaction movements comprises detecting movements performed in the real world with the first hand of the user so that the representation of the first hand in the virtual space moves with respect to a fixed virtual interaction object present in the virtual space, the representation of the first hand being displayed at a position in the virtual space corresponding to the position of the first hand in the real space where the user is located while the interaction movements are performed, wherein the virtual interaction object is a fixed virtual object in audiovisual content reproduced by the immersion device.

11. The method according to claim 1, wherein detecting interaction movements comprises detecting movements made in the real world with the first hand of the user so that the representation of the first hand in the virtual space moves with respect to a fixed virtual interaction object present in the virtual space, the representation of the first hand being displayed at a position in the virtual space corresponding to the position of the first hand in the real space where the user is located during the interaction movements, wherein the virtual interaction object is a virtual object representing a fixed real object.

12. The method according to claim 4, wherein the physical contact occurs between the first hand and the fixed real object.

13. The method according to claim 1, wherein said at least one virtual authentication object comprises a device for entering a secret code corresponding to a time sequence of input actions forming the time series of secret interaction movements known to the user, the detection of interaction movements comprising the detection of input actions performed by the user by interacting with the input device.

14. The method according to claim 1,
wherein said at least one virtual authentication object comprises several virtual authentication objects each associated with at least one respective interaction movement, the time series of interaction movements known to the user being a time series of interaction movements each of which is an interaction movement associated with one of the virtual authentication objects,
wherein an interaction movement with a virtual authentication object comprises at least one movement among a movement for moving the virtual object, a movement for rotating the virtual object, a movement for selecting the virtual object and a movement for modifying the appearance of the virtual object.

15. (canceled)

16. A device comprising at least one processor and at least one memory comprising program instructions configured to cause, when executed by the at least one processor, the device to perform:
detecting a first hand of the user placed in front of a camera of the immersion device;
displaying a representation of the first hand of the user in the virtual space while the first hand is detected;
displaying at least one virtual authentication object projected onto the representation of the first hand in the virtual space;
detecting interaction movements performed by the user in the virtual space with said at least one virtual authentication object while said at least one virtual authentication object is displayed projected on the representation of the first hand in the virtual space;
obtaining a user authentication decision based on at least two authentication factors including a first biometric factor verified from a biometric print acquired by the immersion device for the first hand while the first hand is detected and a second knowledge factor verified by comparing the detected interaction movements with a time series of secret interaction movements known to the user.
